(19) United States
(12) Patent Application Publication
(10) Pub. No.: US 2006/0090609 A1
(43) Pub. Date: May 4, 2006

(54) Ratchet wrench

(76) Inventor: Chih-Min Chang, Changhua Hsien (TW)

Correspondence Address: BROWDY AND NEIMARK, P.L.L.C.;624 NINTH STREET, NW, SUITE 300, WASHINGTON, DC, 20001-5303, US

(21) Appl. No.: 10/980,257

(22) Filed: Nov. 4, 2004

(51) Int. Cl. B25B 13/46

(52) U.S. Cl. 81/63.2

(57) ABSTRACT

A ratchet wrench includes a handle having a head portion provided with a through hole, an inside chamber laterally recessed from a surrounding wall of the through hole, and a top notch formed in a top side of the handle in communication with the inside chamber, a driving member with toothed portion rotatably mounted in the through hole of the head portion, a pawl mounted in the inside chamber of the handle and provided with a toothed portion for detachably engaging the toothed portion of the driving member, a switching member fixedly connected to the pawl for moving the pawl along the top notch of the handle, and a positioning device mounted in the inside chamber of the handle for forcing the pawl into engagement with the toothed portion of the driving member.

### BACKGROUND OF THE INVENTION

1. Field of the Invention

The present invention relates a ratchet wrench and more particularly, to a simple structure of ratchet wrench, which is easy to assemble and inexpensive to manufacture.

2. Description of the Related Art

FIG. 6 shows a conventional reversible ratchet wrench. According to this design, the reversible ratchet wrench comprises a box-end handle 91, a driving member 92, a pawl 93, a switching member 94, and a positioning device 95. The driving member 92 is rotatably mounted in the box end of the box-end handle 91. The pawl 93 is mounted in an inside chamber 96 of the handle 91 and adapted to engage the driving member 92. The switching member 94 is inserted through a through hole 97 of the box-end handle 91 and connected to the pawl 93 for operation by the user to move the pawl 93 in the inside chamber 96 between two positions. The positioning device 95 is mounted inside the inside chamber 96 and adapted to force the pawl 93 into engagement with the driving member 92, for enabling the driving member 92 to be moved with the box-end handle 91 to turn a bolt or nut.

According to the aforesaid design, the inside chamber 96 and the through hole 97 extend in different directions. It is necessary to mill the box-end handle 91 twice so as to form the inside chamber 96 and the through hole 97 and to form a bridge 98 between the inside chamber 96 and the through hole 97. This complicated manufacturing procedure greatly increases the manufacturing cost of the ratchet wrench. During installation, the switching member 94 is inserted through the through hole 97 and the pawl 93 and then secured to the pawl 93 with a spring washer 99. This installation procedure is complicated.

### SUMMARY OF THE INVENTION

The present invention has been accomplished under the circumstances in view. It is one objective of the present invention to provide a ratchet wrench, which has a simple structure that is easy to assemble and inexpensive to manufacture.

To achieve this objective of the present invention, the ratchet wrench comprises a handle having a head portion, which is provided with a through hole, an inside chamber laterally recessed from a surrounding wall of the through hole, and a top notch formed in a top side of the handle corresponding to the inside chamber, a driving member rotatably mounted in the through hole for grasping and turning a workpiece, a pawl mounted in the inside chamber for detachably engaging the driving member, a switching member connected to the pawl for moving the pawl along the top notch of the handle, and a positioning device mounted in the inside chamber for forcing the pawl into engagement with the driving member.

### BRIEF DESCRIPTION OF THE DRAWINGS

FIG. 1 is a perspective view of a ratchet wrench according to the present invention.

FIG. 2 is an exploded view of the ratchet wrench according to the present invention.

FIG. 3 is a sectional view taken along line 3-3 of FIG. 1.

FIG. 4 is a sectional view taken along line 4-4 of FIG. 1, showing the pawl stopped against the driving member from counterclockwise rotation.

FIG. 5 is similar to FIG. 4 but showing the pawl stopped against the driving member from clockwise rotation.

FIG. 6 is an exploded view of a ratchet wrench according to the prior art.

### DETAILED DESCRIPTION OF THE INVENTION

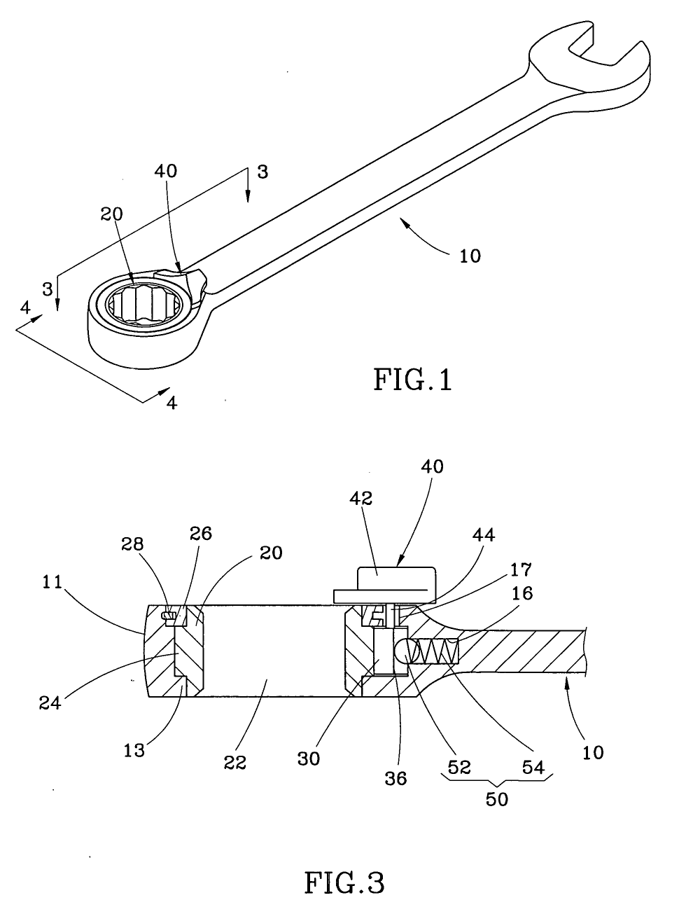

Referring to FIGS. 1-3, a ratchet wrench in accordance with the present invention is shown comprised of a handle 10, a driving member 20, a pawl 30, a switching member 40, and a positioning device 50.

The handle 10 has a head portion 11 at one end. The head portion 11 has a through hole 12 through the top and bottom sides thereof, two annular flanges 13 respectively formed in the top and bottom sides around the two distal ends of the through hole 12, and a locating groove 14 formed in the inner diameter of one annular flange 13 that is at the top side of the head portion 11. The handle 10 further has a smoothly arched inside chamber 15, which is laterally recessed from one side of the surrounding wall of the through hole 12 and is in communication with the through hole 12 at one side, a locating hole 16 longitudinally backwardly extended from the center of the inside wall of the inside chamber 15 toward the inside of the handle 10, and an arched top notch 17 formed in the top side corresponding to the border area of the inside chamber 15.

The driving member 20 is shaped like a tube having a dodecagonal coupling hole 22 extended through the top and bottom sides thereof for grasping and turning the workpiece, and a toothed portion 24 extended around the periphery thereof. A mounting ring 26 is fastened to the periphery of the driving member 20 above the toothed portion 24 and inserted with the driving member 20 into the through hole 12 of the head portion 11 of the handle 10. A C-shaped retainer ring 28 is fastened to the periphery of the mounting ring 26 and the locating groove 14 of the head portion 11 of the handle 10 to secure the driving member 20 to the head portion 11 of the handle 10, for enabling the driving member 20 to be rotated in the head portion 11.

The pawl 30 is an arched member having a rectangular mounting hole 32 extended through the top and bottom sides thereof, a toothed portion 34 in the inwardly curved front side, and two receiving portions 36 formed in the back side. The pawl 30 is inserted into the smoothly arched inside chamber 15 of the handle 10 with the toothed portion 34 facing the driving member 20 for engagement with the toothed portion 24 of the driving member 20.

The switching member 40 comprises an operating portion 42 and a coupling portion 44. The coupling portion 44 is a rectangular rod downwardly extended from the bottom side of the operating portion 42 and press-fitted into the rectangular mounting hole 32 of the pawl 30. After installation of the pawl 30 in the smoothly arched inside chamber 15 of the handle 10, the operating portion 42 of the switching member 40 covers the arched top notch 17 and is disposed on the top side of the handle 10 for operation by the user to move the pawl 30 in the smoothly arched inside chamber 15 between two positions.

The positioning device 50 is mounted in the locating hole 16 of the handle 10, and comprised of a ball 52 and a spring 54. The ball 52 is stopped against one of the receiving portions 36 of the pawl 30. The spring 54 imparts a spring force to push the ball 52 toward the pawl 30, having one end stopped at the ball 52 against the pawl 30 and the other end stopped at the bottom end of the locating hole 16.

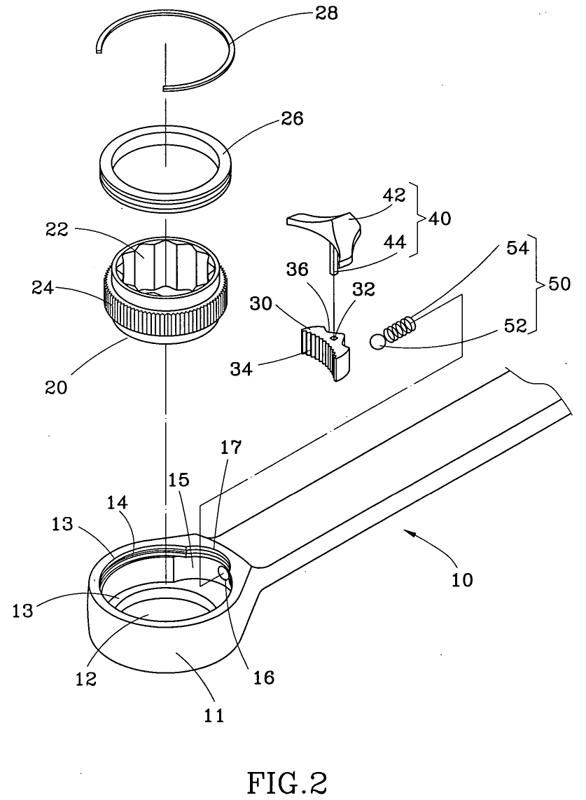

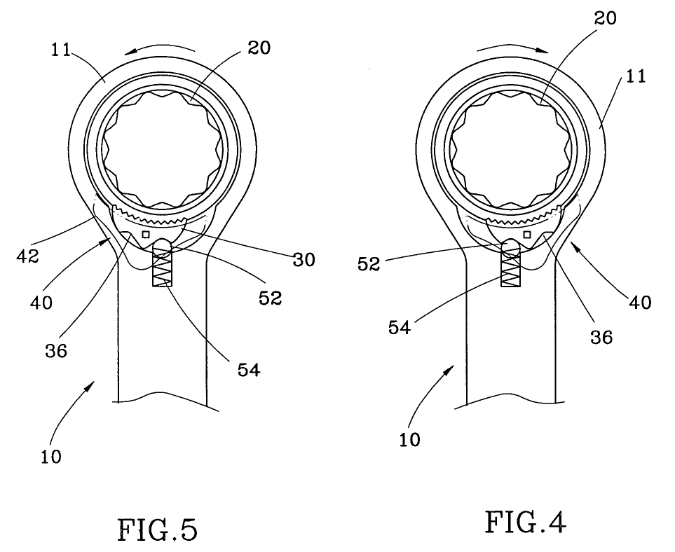

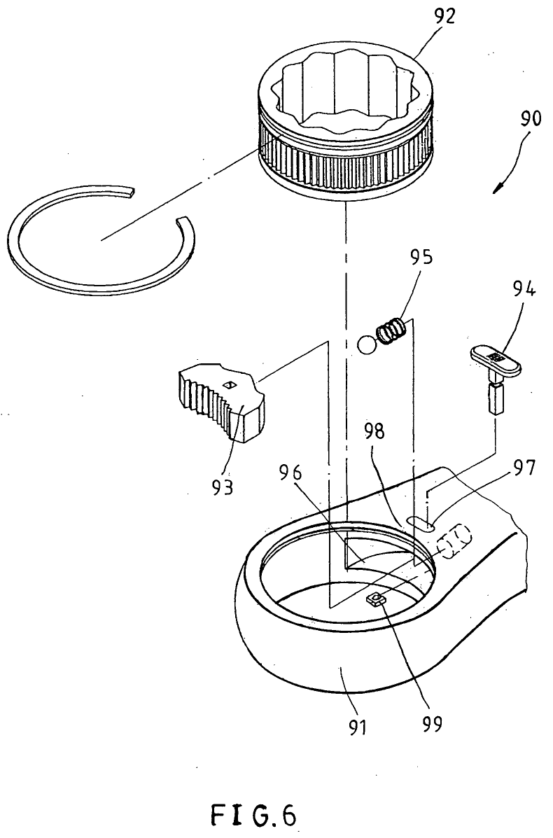

Subject to the aforesaid design, as shown in FIG. 2, the inside chamber 15 and arched top notch 17 of the handle 10 can be formed through one single milling process. During assembly process, the ball 52 and the spring 54 are mounted in the locating hole 16 inside the handle 10, and then the pawl 30 is directly inserted through the through hole 12 into the inside chamber 15 to support the switching member 40 in such a position that the coupling portion 44 is partially engaged into the rectangular mounting hole 32 and partially suspended in the arched top notch 17 of the handle 10 and the operating portion 42 protrudes over the top side of the handle 10, and then the C-shaped retaining ring 28 is fastened to the mounting ring 26 at the driving member 20 and the locating groove 14 in one annular flange 13 of the head portion 11 to secure the driving member 20 to the inside of the through hole 12. When assembled, the user can operate the switching member 40 to move the pawl 30 and to further control the direction of rotation of the driving member 20. As illustrated in FIG. 4, when the user operated the switching member 40 to move the pawl 30 to one corner in the inside chamber 15 (the right-side corner in FIG. 4), the driving member 20 is set for clockwise rotation. On the contrary, when the user operated the switching member 40 to move the pawl 30 to the other corner in the inside chamber 15 as shown in FIG. 5, the driving member 20 is set for counterclockwise rotation.

By means of the aforesaid arrangement, the ratchet wrench of the present invention has a simple structure that is easy to assemble and inexpensive to manufacture.

Further, the coupling portion of the switching member and the mounting hole of the pawl can be made having any of a variety of non-circular shapes to achieve the same effect.

What is claimed is:

1. A ratchet wrench comprising:
a handle having a head portion at one end thereof, said head portion having a through hole through top and bottom sides thereof, an inside chamber laterally recessed from a surrounding wall of the through hole, and a top notch formed in a top side of the handle corresponding to and in communication with said inside chamber;
a driving member rotatably mounted in the through hole of said head portion of said handle, said driving member having a coupling hole extended through top and bottom sides thereof for grasping and turning a workpiece and a toothed portion extended around a periphery thereof;
a pawl mounted in said inside chamber of said handle, said pawl having a toothed portion for engaging the toothed portion of said driving member;
a switching member connected to said pawl for moving said pawl along said top notch of said handle; and
a positioning device mounted in said inside chamber of said handle for forcing said pawl into engagement with the toothed portion of said driving member.

2. The ratchet wrench as claimed in claim 1, wherein said pawl has a non-circular mounting hole; said switching member comprises an operating portion for turning by the user, and a coupling portion extended from said operating portion and fastened to the non-circular mounting hole of said pawl, said coupling portion having a cross section fitting a cross section of said non-circular mounting hole.

3. The ratchet wrench as claimed in claim 1, wherein said handle further comprises a locating hole axially backwardly extended from said inside chamber; said positioning device comprises a spring mounted in said locating hole of said handle, and a round ball supported on said spring and forced by said spring into contact with the pawl.
